(19) United States
(12) Patent Application Publication
(10) Pub. No.: US 2009/0192818 A1
(43) Pub. Date: Jul. 30, 2009

(54) SYSTEMS AND METHOD FOR CONTINUOUS HEALTH MONITORING

(75) Inventors: Matthew C. Compton, Tucson, AZ (US); Louis D. Echevarria, Tucson, AZ (US); Nikhil Khandelwal, Tucson, AZ (US); Michael R. Maletich, Tucson, AZ (US); Ricardo S. Padilla, Tucson, AZ (US); Robin D. Roberts, Tucson, AZ (US); Steve P. Wallace, Casa Grande, AZ (US); Richard A. Welp, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/021,955

(22) Filed: Jan. 29, 2008

(51) Int. Cl. G06Q 50/00; G06Q 10/00

(52) U.S. Cl. 705/2

(57) ABSTRACT

A system for continuous health monitoring includes a computer system including a locking mechanism configured to allow multiple health point checks to be accessed simultaneously, a plurality of component health point checks configured to monitor at least one component of the system and configured to store health monitoring statistics in the computer system, and a scheduler configured to periodically enable the plurality of component health point checks based on one of a user request and a predefined amount of time.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention generally relates to computer system health monitoring. More particularly, this invention relates to a system and method for continuous health monitoring.

2. Description of Background

As system functions become more and more complex, the requirements of complete system health reporting grow proportionally. Every network and module which is added to systems becomes one more verification or check point that must be performed, with numerous dependencies existing between each module. Furthermore, any user may demand to receive a health report almost instantaneously. Performing health checks in a manner which ensures usability, correctness, and completeness has proven almost impossible.

System checkout functions have been used throughout early tape products. However, these functions executed an exhaustive check on each user request. Furthermore, the numerous modular checks were performed one-by-one, with some of them lasting several minutes. Although previous implementations provided a complete health report of a system, the execution proved unusable.

### SUMMARY

A system for continuous health monitoring includes a computer system including a locking mechanism configured to allow multiple health point checks to be accessed simultaneously, a plurality of component health point checks configured to monitor at least one component of the system and configured to store health monitoring statistics in the computer system, and a scheduler configured to periodically enable the plurality of component health point checks based on one of a user request and a predefined amount of time.

A method for continuous health monitoring includes initiating a plurality of component health checks of a computer system includes logging component health check change history in a storage system of the computer system, logging output of the plurality of component health checks, and continuously updating the plurality of component health checks.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a system to perform health monitoring, according to an exemplary embodiment;

FIG. 2 illustrates a flowchart of a method for performing health monitoring, according to an exemplary embodiment;

FIG. 3 illustrates a flowchart of a method for reporting health monitoring statistics, according to an exemplary embodiment; and

FIG. 4 illustrates a distributed system including health monitoring, according to an exemplary embodiment; and

FIG. 5 illustrates a computer apparatus for a health monitoring application, according to an exemplary embodiment.

The detailed description explains an exemplary embodiment, together with advantages and features, by way of example with reference to the drawings.

### DETAILED DESCRIPTION

According to an exemplary embodiment, a method is provided which significantly increases the availability of health statistics for systems. This increase in availability results in a decrease in overall time waiting for health statistics reporting, and may increase the usability of complex systems.

According to example embodiments, a pluggable architecture is provided to give real time health statistics of a distributed system. The system is able to integrate existing modular health checks that may require intermittent polling with newer health checks that can update health statistics in real-time. The real-time health process consists of a persistent store for the health, a set of tools for updating the health statistics, a daemon to run and coordinate the checks, and a display environment that can generate health status reports using a cross-platform format. The architecture allows for maintaining the health status on a set of distributed machines by alerting the remote systems of changes as they occur. If the initial framework is integrated, existing modular health checks are easily implemented and new modular health checks are relatively quickly installed.

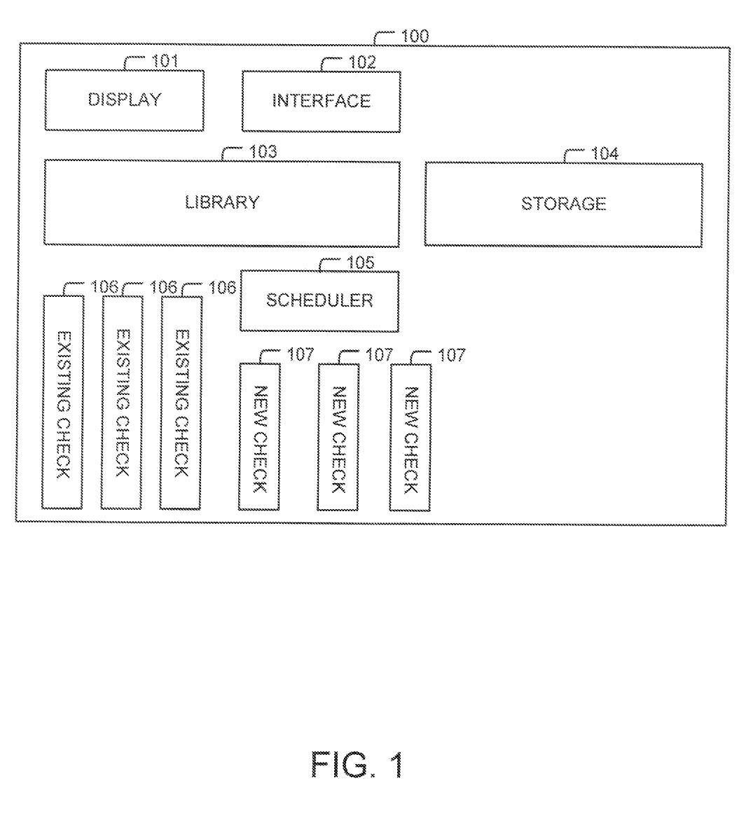

Turning to FIG. 1, a system to perform health monitoring is illustrated. The system 100 includes a display 101 and an interface 102. The display 101 may be any display device. The interface 102 may be an interface allowing a user to issue commands and/or instructions to the system 100. For example, the interface 102 may be a command line interface. The system 100 further includes library 103. The library 103 may include a plurality of definitions and functions associated with health monitoring.

The system 100 further includes computer storage 104. Storage 104 may be a backend storage system such as a database or file system of a computer system, or alternatively, may be a remote server or storage system such as a computer system or remote computer system. Storage 104 supports a locking mechanism allowing multiple health point updates to occur simultaneously without corruption of vital health statistics.

The system 100 further includes scheduler 105. It is noted that as used herein scheduler 105 may be similar to the daemon described above. Therefore, according to example embodiments, the terms scheduler and daemon may be used interchangeably. Furthermore, a scheduler could be termed a scheduler or scheduling daemon, and a daemon could be termed the same.

Turning back to FIG. 1, scheduler 105 is responsible for running component health checks and avoiding potential conflicts. The scheduler 105 may keep track of when checks were last run and which checks are currently running. In order to avoid conflicts, the scheduler 105 may store a listing of checks that cannot be run simultaneously due to resource conflicts. The scheduler 105 may also ensure that too many checks are not running at any given time (i.e., to avoid resource abuse), and that an individual check does not have multiple instances active at the same time. The scheduler 105 may also keep track of how long individual checks are running, and may force a check to terminate if the check is running for a predetermined or desired amount of time (i.e., to avoid system hang-ups).

In addition to scheduling checks, the scheduler 105 may allow a user to manually execute a health check. The manual execution may be useful if service personnel repair a failed component. If a user manually executes a component check, the same conflicts above must be verified.

The system 100 further includes a plurality of component health checks. For example, the system, as illustrated, includes a plurality of existing modular checks 106 and a plurality of new modular checks 107. The plurality of existing modular checks 106 may be checks existing at system start-up, and/or may be scheduled to run at allotted time intervals. The plurality of new modular checks 107 may be checks inserted after system start-up in the modular system and/or may be run based on events (i.e., event driven checks). The component health checks may be responsible for actually verifying the status of various components in the system, and reporting the status using the health point storage mechanism (e.g., storage 104).

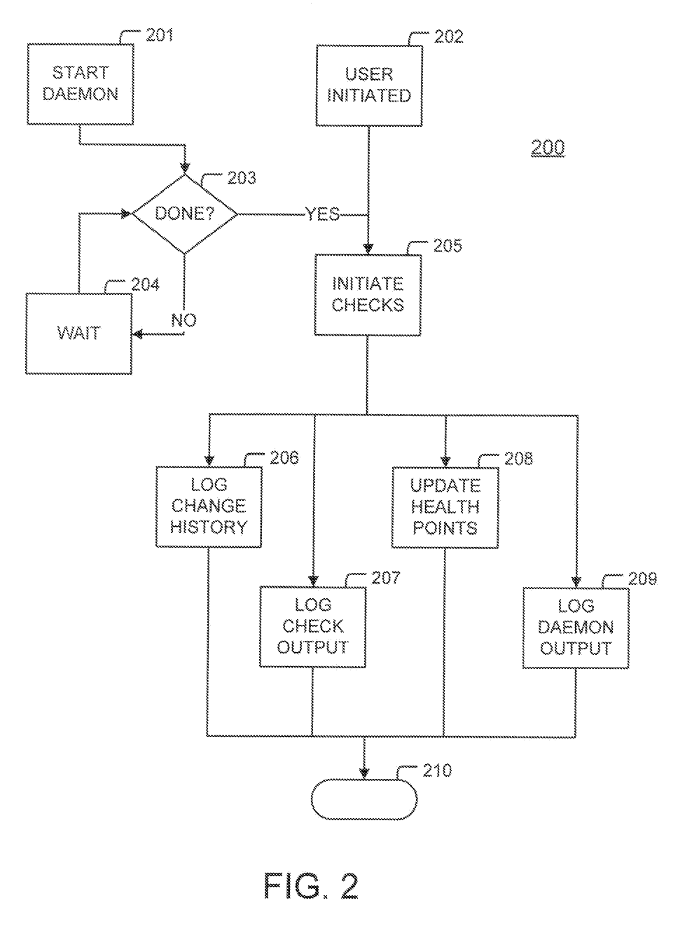

All component health checks may manage at least one (or more) health points using the health point storage mechanism. In addition, each component health check may log details about each individual health point check run. Log files may be archived using a standardized mechanism. Log files may be used by service personnel or support personnel to assist in diagnosing problems with a system. The storage mechanism may be a portion of a computer system being monitored, or part of a remote computer system as described above. Hereinafter, a method of health monitoring is described With reference to FIG. 2.

Turning to FIG. 2, a flowchart of a method 200 of health monitoring is illustrated. The method 200 may include receiving user input at block 202. The user input may include a request to initiate a heath check of a system. At substantially the same time, the system may start a health check by starting a health check daemon at block 201. If the health check daemon is started at block 201, the method 200 includes performing health checks at regular intervals (i.e., time intervals, or heart beats) through iterative block sequence 203 and 204. If an interval is done (i.e., see block 203 “YES” branch), the method 200 includes initiating health checks at block 205.

If health checks are initiated, the method 200 includes logging change history (block 206), logging health check output (block 207), updating health points (block 208), and logging daemon output (block 209) in a relatively parallel manner. Alternatively, the method 200 may perform blocks 206, 207, 208, and 209 in any other parallel and/or sequential combination. Upon completion of health checks (see terminal block 210), the method may return to the wait interval loop 203-204, or terminate health checks until the system restarts the daemon or a user initiates the health checks again.

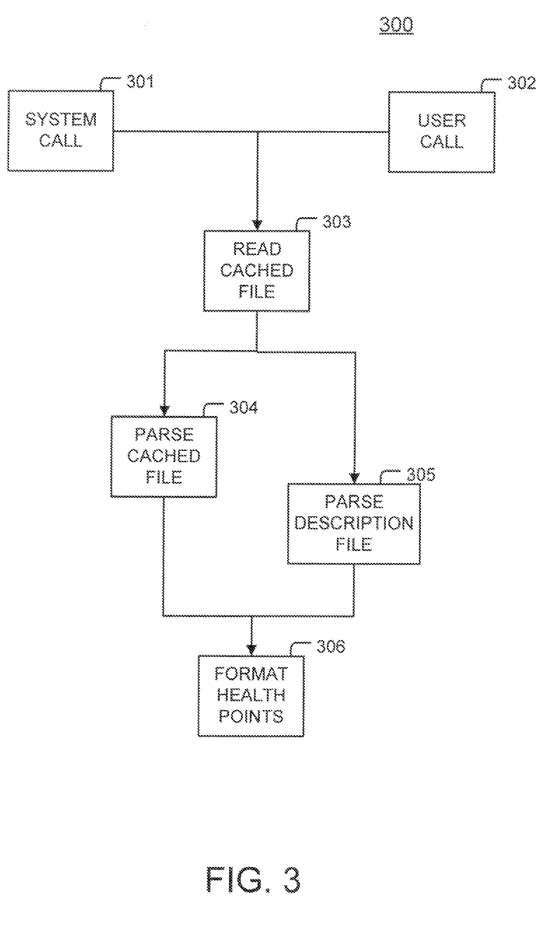

System health may be reported to an end-user and/or service user via several different interfaces (e.g., text-based interfaces, web interfaces, etc). Turning to FIG. 3, a method 300 of health statistic reporting is illustrated. The method 300 may include receiving a system call to perform health reporting at block 301. Alternatively, the method 300 may include receiving a user call to perform health reporting at block 302.

The method further includes reading a cached file at block 303. The cached file may be stored in a storage area (e.g., storage 104). The cached file may include health statistic logs reflecting health check results from a plurality of health checks, descriptions of health checks, and/or other vital health check information. The results may have been stored from a plurality of instances of a health monitoring method as described with reference to FIG. 2.

As shown in FIG. 3, the method 300 further includes parsing the cached health file at block 304 and parsing a description file at block 305. The description file and the health file may be included in the cached file and the parsing may be performed relatively in parallel. The reporting mechanism may use a similar locking mechanism as the health-point storage (i.e., storage 104) described with reference to FIG. 1 in order to reduce possible conflicts. The method 300 further includes formatting health points for reporting at block 306. Upon receiving the health points, an interface may format and display the object's health to a user.

According to at least one example embodiment, the health check information is formatted into a platform independent format. For example, this platform independent format may be accessible by a webpage, a user terminal, a user interface, or a command line interface. An example of a platform independent format may be extensible markup language (XML) format or other somewhat similar formats allowing multiple computing platform access to health information after formatting.

The health reporting mechanism may also be responsible for combining health points into virtual health objects. Virtual health objects may be used in order to combine several individual health points into a single “virtual” component. For example, a virtual object of a car may include health points of the tires, engine, transmission, etc.

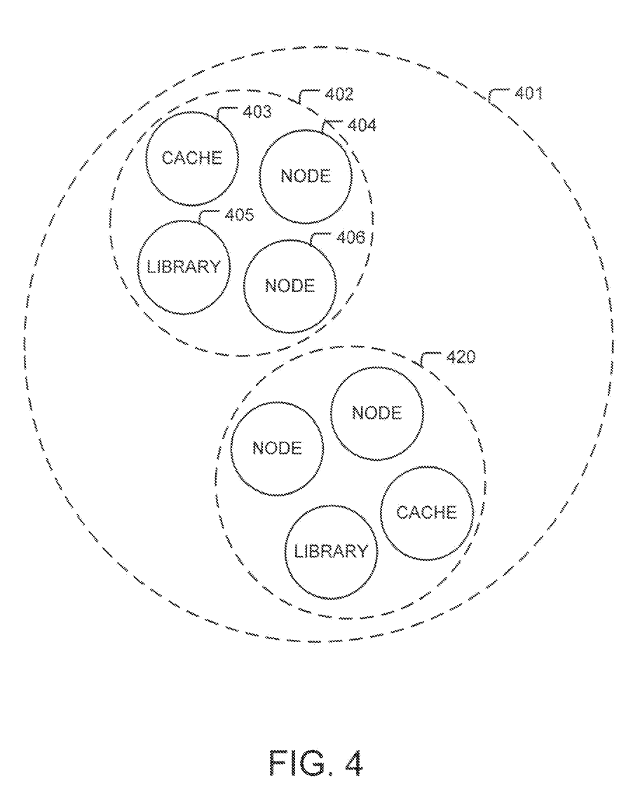

The health check storage and reporting mechanisms described hereinbefore may be extendable to a distributed system environment. For example, FIG. 4 illustrates a distributed system including health monitoring, according to an example embodiment.

According to FIG. 4, the system 401 may have a plurality of clusters (402, 420). Each cluster of the plurality of clusters may include a plurality of nodes (403, 404, 405, 406). If multiple systems (or nodes) are running individual instances of the health monitoring system and/or method, health points can be shared among the various nodes, or may be linked to a single “common” node. By sharing the health points across multiple nodes, the total health of the entire domain can be viewed from a single point of service. This may allow for more efficient service and maintenance of the entire distributed system.

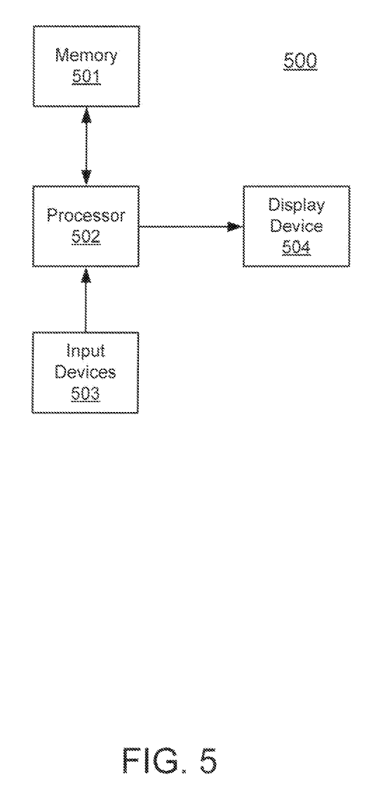

Furthermore, according to an exemplary embodiment, the methodologies described hereinbefore may be implemented by a computer system or apparatus. For example, FIG. 5 illustrates a computer apparatus for attaching documents, according to an exemplary embodiment. Therefore, portions or the entirety of the method may be executed as instructions in a processor 502 of the computer system 500. The computer system 500 includes memory 501 for storage of instructions and information, input device(s) 503 for computer communication, and display device 504. Thus, the present invention may be implemented, in software, for example, as any suitable computer program on a computer system somewhat similar to computer system 500. For example, a program in accordance with the present invention may be a computer program product causing a computer to execute the example method described herein.

The computer program product may include a computer-readable medium having computer program logic or code portions embodied thereon for enabling a processor (e.g., 502) of a computer apparatus (e.g., 500) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

With an exemplary embodiment of the present invention having thus been described, it will be obvious that the same may be varied in many ways. The description of the invention hereinbefore uses this example, including the best mode, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Such variations are not to be regarded as a departure from the spirit and scope of the present invention, and all such modifications are intended to be included within the scope of the present invention as stated in the following claims.

What is claimed is:

1. A system for continuous health monitoring, comprising:
a computer system including a locking mechanism configured to allow multiple health point checks to be accessed simultaneously;
a plurality of component health point checks configured to monitor at least one component of the system and configured to store health monitoring statistics in the computer system; and
a scheduler configured to periodically enable the plurality of component health point checks based on one of a user request and a predefined amount of time.

2. The system of claim 1, further comprising:
a display device configured to display the stored health monitoring statistics.

3. The system of claim 1, further comprising:
an interface configured to receive user input responsive to health monitoring requests.

4. The system of claim 1, further comprising:
a library storing a plurality of resources related to the plurality of component health point checks.

5. The system of claim 1, wherein the scheduler is configured to monitor the status of when a particular component health point check was previously executed.

6. The system of claim 1, wherein the scheduler is configured to store a listing of component health point checks that cannot be enabled simultaneously.

7. The system of claim 1, wherein the scheduler is configured to monitor the status of the plurality of component health point checks to avoid resource abuse.

8. The system of claim 1, wherein the scheduler is configured to terminate a component health point check if a predefined amount of time has elapsed during execution.

9. The system of claim 1, wherein the plurality of component health point checks includes:
a plurality of modular checks configured to execute health checks at specified time intervals; and
a plurality of modular health checks configured to execute health checks at event driven intervals.

10. The system of claim 1, wherein the plurality of component health point checks are configured to archive log details about individual health checks within the storage system using the locking mechanism.

11. A method for continuous health monitoring, comprising:
initiating a plurality of component health checks of a computer system;
logging component health check change history in a storage system of the computer system;
logging output of the plurality of component health checks; and
continuously updating the plurality of component health checks.

12. The method of claim 11, further comprising:
receiving a user signal; and
initiating the plurality of component health checks in response to the user signal.

13. The method of claim 11, further comprising:
starting a scheduling daemon;
measuring time intervals in response to the scheduling daemon; and
initiating the plurality of component health checks at expired time intervals based on the measurements.

14. The method of claim 13, further comprising:
logging output from the scheduling daemon; and
reporting output from the scheduling daemon.

15. The method of claim 11, further comprising:
reading a cached file stored in the storage system;
parsing the cached file to retrieve health check information;
parsing the cached file to retrieve health check descriptions; and
formatting the health check information and health check descriptions.

16. The method of claim 15, further comprising:
reporting the formatted health check information and health check descriptions.

17. The method of claim 11, wherein the computer system is a distributed system including a plurality of nodes, and wherein each node of the plurality of nodes:
initiates a plurality of component health checks for the node;
logs component health check change history in a storage system of the distributed system;
logs output of the plurality of component health checks; and
continuously updates the plurality of component health checks.
